(19) United States
(12) Patent Application Publication
(10) Pub. No.: US 2010/0321947 A1
(43) Pub. Date: Dec. 23, 2010

(54) VEHICLE LIGHTING DEVICE

(75) Inventor: Yoshihiko HAMASHIMA, Tokyo (JP)

Correspondence Address: FOLEY AND LARDNER LLP;SUITE 500, 3000 K STREET NW, WASHINGTON, DC, 20007, US

(73) Assignee: ICHIKOH INDUSTRIES, LTD.

(21) Appl. No.: 12/486,966

(22) Filed: Jun. 18, 2009

(51) Int. Cl. F21V 7/00

(52) U.S. Cl. 362/517; 362/516; 362/547

(57) ABSTRACT

A reflector made of a synthetic resin material is positioned and fixed in a heat sink member. At a position spaced from the positioned and fixed portion, a deformation prevention portion for preventing a warping deformation of the reflector is provided for a respective one of the reflector and the heat sink member, thus preventing a warping deformation of the reflector due to a heat generated from a semiconductor-type light source. As a result, the impairment of light distribution performance, caused by a slight warping deformation of the reflector, is avoided. In this manner, a thermal deformation of the reflector due to the heat generated from the semiconductor-type light source is prevented.

### BACKGROUND OF THE INVENTION

1. Field of the Invention

The present invention relates to vehicle lighting device employed as a headlamp or a rear combination lamp of a vehicle.

2. Description of the Related Art

In recent years, a self-emitting semiconductor-type light source such as a light emitting diode (LED) is employed as a light source of a vehicle lighting device such as a headlamp.

Such a semiconductor-type light source constitutes a light source unit together with a reflector for reflecting light from the light source in a predetermined direction, and is arranged in a lamp room made up of a housing and an outer lens (see Patent Document 1, i.e., Japanese Laid-open Patent Application No. 2004-207235).

### DISCLOSURE OF THE INVENTION

### Problem(s) to Be Solved by the Invention

A semiconductor-type light source employed as a light source of a vehicle light device tends to have higher luminance more strongly in order to enhance an illumination effect, and a heat value thereof also increases with such higher luminance. As a measure for restraining a temperature rise of this semiconductor-type light source, a heat sink has been employed, thereby precisely positioning and mounting the semiconductor-type light source and a reflector in the heat sink.

On the other hand, the reflector is typically die-molded with a synthetic resin material with a good moldability in order to form an intricately curved reflecting surface.

Thus, even if a reflector made of a synthetic resin material is precisely positioned and fixed in a heat sink, in a case where the reflector is finely warped or deformed due to a thermal influence exerted by a heat from the semiconductor-type light source, a light reflection direction goes wrong, disabling the reflector to attain a predetermined light-distribution performance. Accordingly, the present invention aims to provide a vehicle lighting device which is capable of preventing the impairment of light distribution performance, even if the reflector made of the synthetic resin material is subjected to the thermal influence exerted by the heat from the semiconductor-type light source.

### SUMMARY OF THE INVENTION

### Means for Solving the Problem(s)

A first aspect of the present invention is directed to a vehicle lighting device, comprising: (i) a semiconductor-type light source; (ii) a reflector having a reflecting surface for reflecting light from the semiconductor-type light source in a predetermined direction; (iii) a heat sink member in which the semiconductor-type light source and the reflector are positioned and fixed therein, the heat sink member being adapted to radiate a heat from the semiconductor-type light source; and (iv) a deformation prevention portion which is provided for a respective one of the reflector and the heat sink member at a position spaced from the positioned and fixed portion in (iii) and prevents a warping deformation of the reflector due to a heat from the semiconductor-type light source.

A second aspect of the present invention is directed to the vehicle lighting device according to the first aspect, wherein: the deformation prevention portion is made up of a hook mechanism engaged between the reflector and the heat sink, thereby restraining a deformation movement in a respective one of directions in which the reflector is spaced from and approaches the heat sink.

A third aspect of the present invention is directed to the vehicle lighting device according to the first aspect, wherein: the deformation prevention portion is made up of an abutment mechanism for restraining the deformation movement in the direction in which the reflector approaches the heat sink member; and the abutment mechanism comprises an abutment piece which is provided at either one of the reflector and the heat sink member and an abutment seat portion which is provided at the other one, against which the abutment piece abuts.

A fourth aspect of the present invention is directed to the vehicle lighting device according to the third aspect, wherein: the abutment piece and the abutment seat portion of the abutment mechanism abuts in linear contact with each other.

A fifth aspect of the present invention is directed to the vehicle lighting device according to the first aspect, wherein: the deformation prevention portion is provided at a respective one of left and right sides of the reflector and the heat sink member.

A sixth aspect of the present invention is directed to a vehicle lighting device, comprising: (i) a semiconductor-type light source; (ii) a reflector having a reflecting surface for reflecting light from the semiconductor-type light source in a predetermined direction; (iii) a heat sink member in which the semiconductor-type light source and the reflector are positioned and fixed in a first location, the heat sink member being adapted to radiate a heat from the semiconductor-type light source; and (iv) a deformation prevention portion for preventing a warping deformation of the reflector due to the heat from the semiconductor-type light source, the deformation prevention portion being formed by the reflector being positioned and fixed in the heat sink member in a second location spaced from the portion positioned and fixed in the first location of (iii).

A seventh aspect of the present invention is directed to the vehicle lighting device according to the sixth aspect, wherein: the deformation prevention portion is made up of a hook mechanism which is provided for a respective one of the reflector and the heat sink member, which is engaged therewith, and which restrains the deformation movement in directions in which the reflector is spaced from and approaches the heat sink member in the second location.

An eighth aspect of the present invention is directed to the vehicle lighting device according to the sixth aspect, wherein: the deformation prevention portion comprises an abutment mechanism in which the reflector is formed in abutment against the heat sink member in a third location between the first location and the second location, the abutment mechanism being adapted to restrain the deformation movement in the direction in which the reflector approaches the heat sink member.

A ninth aspect of the present invention is directed to the vehicle lighting device according to the eighth aspect, wherein: the abutment mechanism comprises an abutment piece provided at either one of the reflector and the heat sink member and an abutment seat portion provided at the other one, against which the abutment piece abuts.

A tenth aspect of the present invention is directed to the vehicle lighting device according to the eighth aspect, wherein: a plurality of ribs are erected on a back face of the heat sink member; and the abutment mechanism is arranged on a top face of the heat sink member corresponding to the plurality of ribs erected on the back face of the heat sink member.

An eleventh aspect of the present invention is directed to the vehicle lighting device according to the ninth aspect, wherein: the abutment piece and the abutment seat portion of the abutment mechanism abut in linear contact with each other.

A twelfth aspect of the present invention is directed to the vehicle lighting device according to the sixth aspect, wherein: the deformation prevention portion comprises: a hook mechanism which is provided for a respective one of the reflector and the heat sink member and restrains a deformation movement in the direction in which the reflector is spaced from and approaches the heat sink member at the second location; and an abutment mechanism in which the reflector is formed in abutment against with the heat sink member at the third location between the first location and the second location, the abutment mechanism being adapted to restrain the deformation movement in the direction in which the reflector approaches the heat sink member.

A thirteenth aspect of the present invention is directed to the vehicle lighting device according to the sixth aspect, wherein: the deformation prevention portion is provided at a respective one of left and right sides of the reflector and the heat sink member.

A fourteenth aspect of the present invention is directed to a vehicle lighting device, comprising: (i) first and second semiconductor-type light sources; (ii) a first reflector having a reflecting surface for reflecting light from the first semiconductor-type light source in a predetermined direction; (iii) a second reflector having a reflecting surface for reflecting light from the second semiconductor-type light source in a predetermined direction; (iv) a heat sink member in which the first semiconductor-type light source and the first reflector are positioned and fixed in a first location and the second semiconductor-type light source and the second reflector are positioned and fixed in parallel thereto, the heat sink member being adapted to radiate a heat from a respective one of the first and second semiconductor-type light sources; and (v) a deformation prevention portion for preventing a warping deformation of the first reflector due to a heat of the first semiconductor-type light source and a warping deformation of the second reflector due to a heat from the second semiconductor-type light source, the deformation prevention portion being formed by the first reflector and the second reflector being positioned and fixed in the heat sink member in a second location upwardly spaced from the portion positioned and fixed in the first location of (iv).

A fifteenth aspect of the present invention is directed to the vehicle lighting device according to the fourteenth aspect, wherein: the first reflector and the second reflector are integrally molded; and the deformation prevention portion comprises: a first hook mechanism which is provided for each of one end side of the first reflector and the heat sink member and restrains a deformation movement in a respective one of directions in which the first reflector is spaced from and approaches the heat sink member, in the second location; and a second hook mechanism which is provided for each of one end side of the second reflector and the heat sink member, and restrains a deformation movement in a respective one of directions in which the second reflector is spaced from and approaches the heat sink member, in the second location.

A sixteenth aspect of the present invention is directed to the vehicle lighting device according to the fourteenth aspect, wherein: the deformation prevention portion comprises: a first abutment mechanism in which the first reflector is formed in abutment against the heat sink member in a third location between the first location and the second location, the first abutment mechanism being adapted to restrain the deformation movement in the direction in which the first reflector approaches the heat sink member; and a second abutment mechanism in which the second reflector is formed in abutment against the heat sink member in the third location, the second abutment mechanism being adapted to restrain the deformation movement in the direction in which the second reflector approaches the heat sink member.

### Advantageous Effect(s) of the Invention

According to the present invention, as the luminance of a semiconductor-type light source becomes higher, a heat value increases accordingly, whereby a reflector made of a synthetic resin material is subjected to a thermal influence; however, a warping deformation of the reflector is prevented by a deformation prevention portion provided for a respective one of the reflector and a heat sink member.

As a result, the impairment of light distribution performance caused by a slight warping deformation of the reflector can be avoided.

### BRIEF DESCRIPTION OF THE DRAWINGS

FIG. 1 is an exploded perspective view showing a semiconductor-type light source, a heat sink member, and a reflector, of a headlamp according to one embodiment of the present invention;

FIG. 2 is a side view showing a state in which the heat sink member and the reflector shown in FIG. 1 are assembled with each other;

FIG. 3 is a perspective rear view of the heat sink member;

FIG. 4 is a perspective view showing a state in which a subsidiary heat sink member is mounted on the rear of the heat sink member; and

FIG. 5 is an explanatory cross-sectional view of the reflector.

### DESCRIPTION OF THE PREFERRED EMBODIMENTS

### Best Mode for Carrying out the Invention

Hereinafter, one embodiment of the present invention will be described in detail by way of example of a headlamp.

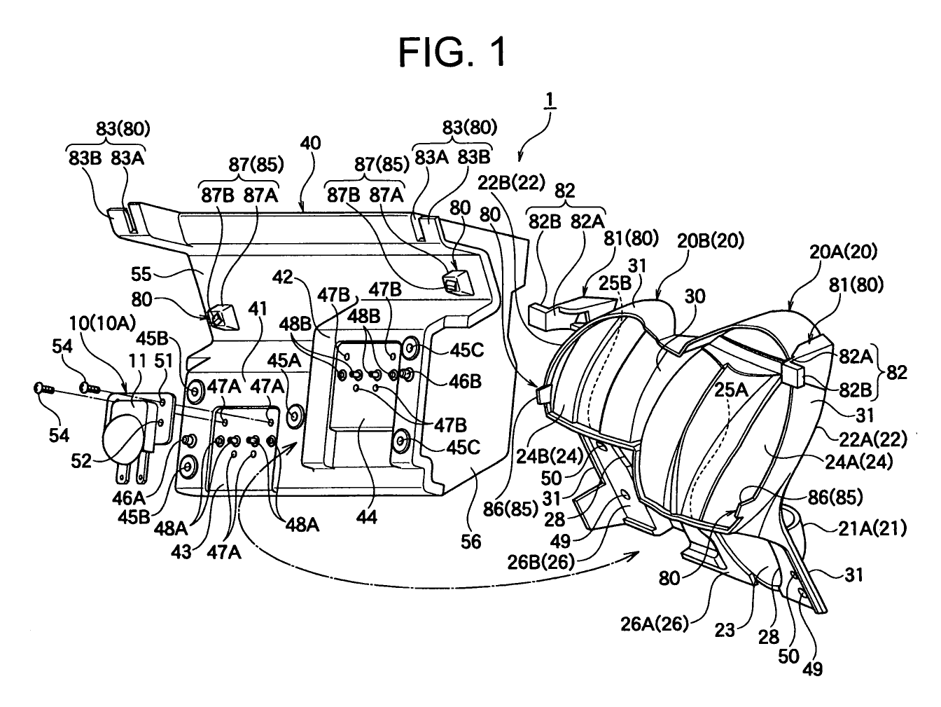

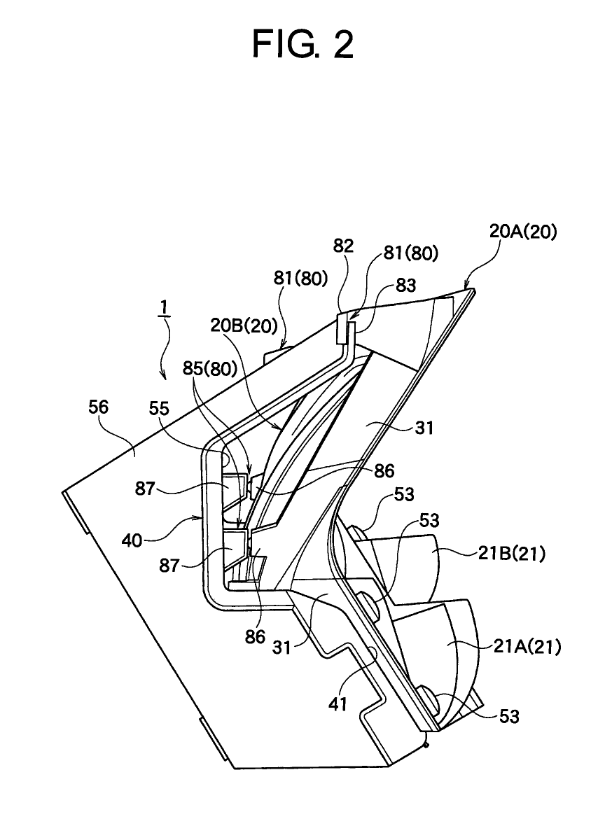

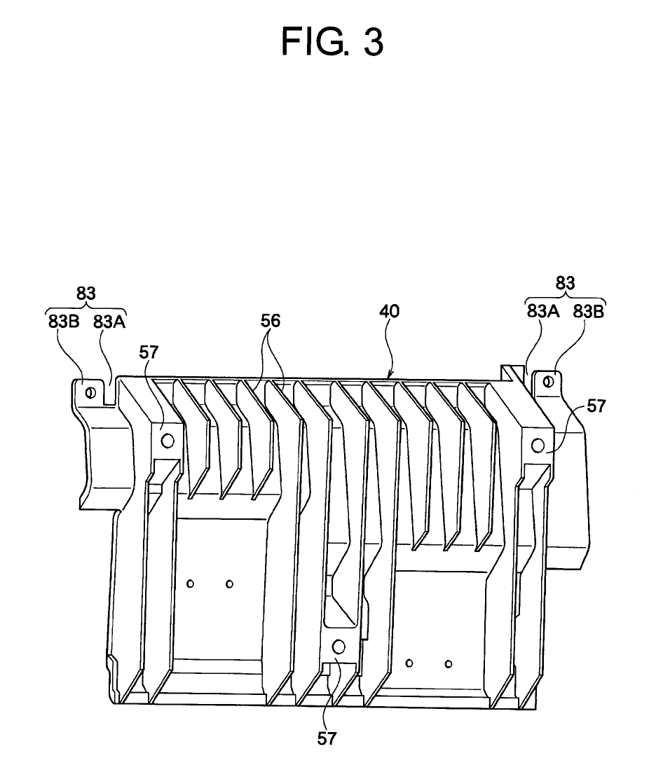

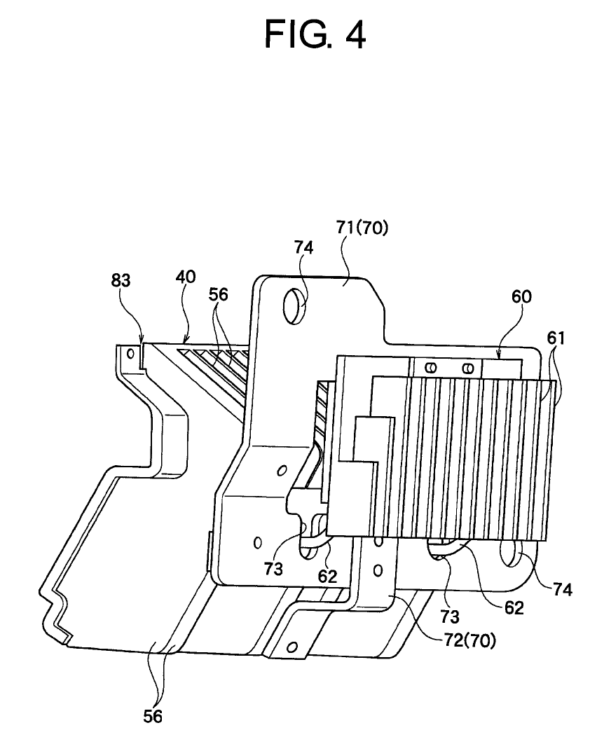

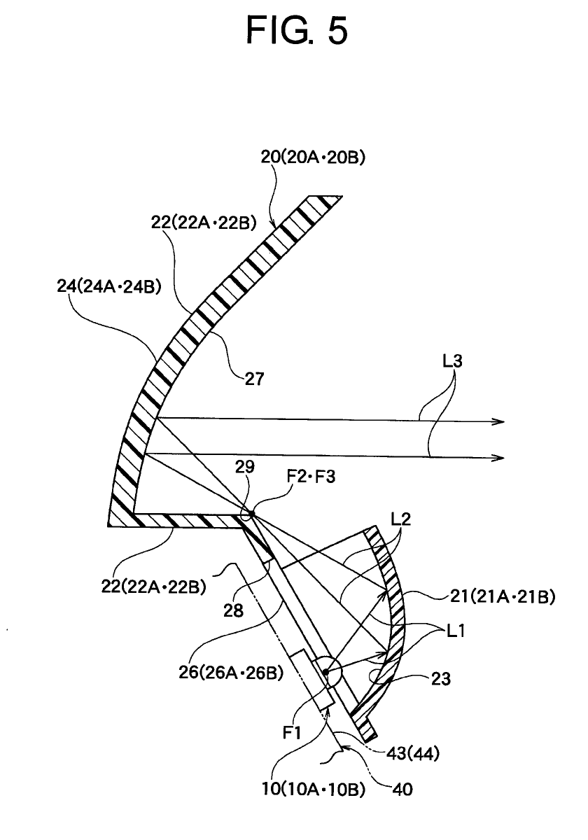

FIG. 1 is an exploded perspective view showing a semiconductor-type light source, a heat sink member, and a reflector of a headlamp, according to the present invention; FIG. 2 is a side view showing a state in which the heat sink member and the reflector are assembled with each other; FIG. 3 is a perspective rear view of the heat sink member; FIG. 4 is a perspective view showing a state in which a subsidiary heat sink member is mounted on the rear face of the heat sink member; and FIG. 5 is an explanatory cross-sectional view of the reflector.

A headlamp according to the embodiment, as shown in FIGS. 1 and 2, is provided with a semiconductor-type light source 10, such as a light emitting diode (LED), a reflector 20, and a heat sink member 40.

A lamp unit 1 is made up of the semiconductor-type light source 10, the reflector 20, and the heat sink member 40. The lamp unit 1 is arranged in a lamp room made up of a housing and an outer lens (not shown), and constitutes a headlamp.

The semiconductor-type light source 10 has a transparent cover 11, and is fixed in the heat sink member 40 together with the cover 11.

In the embodiment, two semiconductor-type light sources 10A, 10B and two reflectors 20A, 20B corresponding to these light sources are provided, a pair of the semiconductor-type light source 10A and the reflector 20A and a pair of the semiconductor-type light source 10B and the reflector 20B are transversely provided together on the front face of the heat sink member 40.

The reflectors 20A, 20B are die-molded with an optically impermeable synthetic resin material. These reflectors 20A, 20B are provided with a first reflector 21 and a second reflector 22, as shown in FIG. 5. The first and second reflectors 21 and 22 are integrally or separately molded. When they are separately molded, the first and second reflectors 21 and 22 are precisely positioned and fixed with tightening members such as screws.

The first reflector 21 is shaped like a quadrant obtained by cutting a rotational ellipse at a long axis and at a short axis. This reflector is opened at the upper and rear sides thereof, and is closed at the front and lower sides thereof and at the left and right sides thereof. A closed part of the frontal portion of the first reflector 21 is formed in a protrusive shape extending to the outside (from the rear side to the front side thereof). Aluminum vapor deposition or sliver coating is applied into a recessed surface of the closed part of the frontal portion of the first reflector 21, and a first reflecting surface 23 is provided.

The first reflecting surface 23 is adapted to reflect light L1 from the semiconductor-type light source 10. The first reflecting surface 23 is an ellipse-based, freely-curved (NURBS-curved) reflecting surface. This ellipse-based, freely-curved reflecting surface is made of a reflecting surface forming an ellipse at a vertical cross section shown in FIG. 5 and forming a parabola or a transformed parabola at a horizontal cross section (not shown). The first reflecting surface 23 has a first focal point F1, a second focal point F2, and an optical axis (not shown). The second focal point F2 is obtained as a focusing curve on a horizontal cross section, i.e., as a focusing curve, such that both ends thereof are positioned at the upper side and the center thereof is positioned at the lower side, as viewed from the front side. The freely-curved surface of the first reflecting surface 23 is a NURBS freely-curved surface (Non-Uniform Rational B-Spline Surface) described in literature entitled “Mathematical Elements for Computer Graphics” (David F. Rogers, J Alan Adams). The first reflecting surface 23 may be a reflecting surface made of a mere rotational elliptical surface having a first focal point, a second focal point, and an optical axis. In this case, the second focal point is obtained as a focal point, not as a focusing curve.

The second reflector 22 is integrally made up of an obliquely curved plate portion 24, a horizontal flat plate portion 25, and an oblique flat plate portion 26. Aluminum vapor deposition or silver coating is applied onto a front face of the obliquely curved plate portion 24 of the second reflector 22, and a second reflecting surface 27 is provided. An opening 28 is provided at the center of the oblique flat plate portion 26, and the first reflector 21 is provided so as to surround the opening.

The second reflecting surface 27 is adapted to reflect reflected light ray L2 from the first reflecting surface 23 as reflected light ray L3 forwardly of a vehicle. The second reflecting surface 27 is a parabola-based, freely curved (NURBS-curved) reflecting surface. The parabola-based, freely curved surface is made of a reflecting surface forming an ellipse at a vertical cross section of FIG. 5 and forming a parabola or a transformed parabola at a horizontal cross section (not shown). The second reflecting surface 27 has a focal point F3 and an optical axis (not shown). The focal point F3 is positioned at the second focal point F2 of the first reflecting surface 23, and is obtained as a focusing curve on the horizontal cross section, i.e., as a focusing curve curved so that both ends thereof are positioned at the upper side and the center thereof is positioned at the lower side, as viewed from the front side. The freely-curved surface of the second reflecting surface 27 (NURBS-curved surface), like the freely-curved surface of the second reflecting surface 27 (NURBS-curved surface), is a NURBS freely-curved surface (Non-Uniform Rational B-Spline Surface) described in the literature entitled “Mathematical Elements for Computer Graphics” (David F. Rogers, J Alan Adams).

The oblique flat plate portion 26 is a shade adapted to: shield a part of the reflected light ray L2 traveling from the first reflecting surface 23 to the second reflecting surface 27; and form a predetermined light distribution pattern (not shown) having a cutoff line (not shown), for example, a light distribution pattern for passing (low-beam light distribution pattern) with remains of the reflected light ray L2 that has not been shielded. An edge 29 forming the cutoff line of the predetermined light distribution pattern is provided at a corner between the horizontal flat plate portion 25 and the oblique flat plate portion 26. This edge 29 is positioned at or near the focal point F3 of the second reflecting surface 27. Further, in the semiconductor-type light source 10, a light emitting portion thereof is disposed at the first focal point F1 of the first reflecting surface 23.

In the embodiment, two reflectors 20A, 20B are employed as described previously. These two reflectors 20A, 20B are integrally molded via a serially-connected wall 30 at the side rim parts of the second reflectors 22A, 22B. Rib walls 31 are formed at the peripheral rims of the obliquely curved plate portions 24A, 24B and at the side rims of the oblique plat plate portions 26A, 26B, of the second reflectors 22A, 22B. Further, the serially-connected wall 30 is provided between adjacent central rib walls 31, 31.

The reflector 20B is formed to be a size smaller than the reflector 20A, and the horizontal flat plate portion 25B is disposed in such a manner that it is vertically displaced more upwardly than the horizontal flat plate portion 25A (see FIGS. 1 and 2).

The heat sink member 40 is made of a material with a good thermal conductivity, for example, an aluminum die cast in the exemplary embodiment.

On the front face of the heat sink member 40, two reflector mount surfaces 41, 42 inclined obliquely upwardly are transversely provided together in such a manner that they are vertically displaced, in correspondence with oblique flat plate portions 26A, 26B in the reflectors 20A, 20B (see FIG. 1).

At the center portions of the reflector mount surfaces 41, 42, light source mount surfaces 43, 44, for mounting the semiconductor-type light sources 10 (10A, 10B), are step-molded to be lower than usual by one step.

The semiconductor-type light sources 10A, 10B and the reflectors 20A, 20B are precisely positioned and fixed at the light source mount surface 43, 44 and the reflector mount surfaces 41, 42 altogether. For the purpose of this positioning and fixing activity, for example, on the reflector mount surface 41, one screw hole 45A is provided at a side rim part inside of a vehicle widthwise direction thereof; two upper and lower screw holes 45B are provided at a side rim part outside of a vehicle widthwise direction thereof; and a locating pin 46A is provided in the upper vicinity of the lower screw hole 45B. On the reflector mount surface 42, two upper and lower screw holes 45C are provided at the side rim parts outside of a vehicle widthwise direction thereof; and a locating pin 46B is provided in the lower vicinity of the upper screw hole 45C. Further, on the light source mount surfaces 43, 44, a plurality of screw holes 47 (47A, 47B) and locating pins 48 (48A, 48B) are provided, respectively.

On the other hand, at the oblique flat plate portions 26A, 26B of the reflectors 20A, 20B, a screw insert hole 49 and a positioning hole 50 are provided in correspondence with the screw hole 45 and the locating pin 46, and on the semiconductor-type light sources 10A, 10B, a screw insert hole 51 and a positioning hole 52 are provided in correspondence with the screw hole 47 and the locating pins 48 (the screw-insert hole and positioning hole of the light source body are not shown).

The semiconductor-type light sources 10A, 10B are securely tightened and fixed in the screw holes 47A, 47B through the screw insert hole 51 by means of a screw member 54, in a state in which these light sources are precisely positioned in engagement between a respective one of the locating pins 48A, 48B and the positioning hole 52 in a respective one of the light source mount surfaces 43, 44. Afterwards, the reflector 20 is securely tightened and fixed in the screw holes 45A to 45C through the screw insert hole 49 by means of a screw member 53, in a state in which the reflector is precisely positioned in engagement between a respective one of the locating pins 46A, 46B and the positioning hole 50 of a respective one of the oblique flat plate portions 26A, 26B, in a respective one of the reflector mount surfaces 41, 42.

A recessed portion 55, for accepting a portion bent in a lateral V-shape (the obliquely curved plate portion 24 and the horizontal flat plate portion 25), of the reflectors 20A, 20B (the second reflectors 22A, 22B), is formed upwardly of the reflector mount surfaces 41, 42.

Further, on the rear face of the heat sink member 40, a plurality of heat radiation fins 56 are vertically provided in line at appropriate intervals.

In the embodiment, at a rear part of the heat sink member 40, a small subsidiary heat sink member 60 is provided so as to enhance a cooling effect of the semiconductor-type light source 10 (see FIG. 4). Like the heat sink member 40, the subsidiary heat sink member 60 is made of an aluminum die cast, for example. This subsidiary heat sink member 60 is formed in a rectangular shape when it is rearwardly viewed, and a plurality of heat radiation fins 61 are vertically provided in line at appropriate intervals on the rear face thereof.

A plurality of mount seat portions 57 are provided on the rear face of the heat sink member 40, a bracket 70 is securely tightened and fixed at the mount seat portion 57, and the subsidiary heat sink member 60 is mounted via the bracket 70.

The bracket 70 is made up of: a main bracket 71 formed in the shape of a rectangular plate; and a leg-like bracket 72 for disposing the subsidiary heat sink member 60 spaced rearwardly of the main bracket 71.

The heat sink member 40 and the subsidiary heat sink member 60 are connected via two heat pipes 62, for example, and heat exchange therebetween is performed by means of the heat pipes 62.

An opening 73 for cabling the heat pipe 62 is provided at the main bracket 71.

Further, an aiming bolt mount hole 74 is provided at one diagonal corner of the main bracket 71, and an aiming adjustment bolt (not shown) is mounted therein.

Afterwards, at a position spaced from a portion at which the reflector 20 is positionally fixed, a deformation prevention portion 80 for preventing a warping deformation of the reflector 20 is provided for a respective one of the reflector 20 and the heat sink member 40.

As the deformation prevention portion 80, as shown in FIGS. 1 and 2, there may be employed a hook mechanism 81 which is engaged, for restraining the reflector 20 from a deformation movement in a respective one of the directions in which the reflector is spaced from and approaches the heat sink member 40.

FIG. 1 shows the reflector 20 being revered to the back side, for the sake of clear understanding of a structure thereof.

In the embodiment shown in FIG. 1, the hook mechanism 81 is made up of: a hook member 82 at the side of the reflector 20, provided at an upper part of a respective one of the reflector 20 and the heat sink member 40; and a hook member 83 at the side of the heat sink member 40.

Further, in the embodiment, the hook mechanism 81 is provided at a respective one of the left and right side parts of the reflector 20 and the heat sink member 40.

The hook member 82 at the side of the reflector 20 is made up of: a vertical arm portion 82A integrally molded at an upper part of a rib wall 31 outside of the vehicle widthwise direction of a respective one of obliquely curved plate portions 24A, 24B in the second reflectors 22A, 22B; and a hook portion 82B integrally molded to be bent at a substantial right angle outwardly in the vehicle widthwise direction, at a tip end of the arm portion 82A.

A base of the arm portion 82A is integrally formed in the shape of a box together with the rib wall 31, so that a required rigidity can be obtained as to a respective one of the hook member 82 and the rib wall 31.

The hook member 83 at the side of the heat sink member 40 is made up of: a slit 83A to be engagingly attached to by the arm portion 82A of the hook member 82 at the side of the reflector 20; and a hook portion 83B to be engagingly attached to by the hook portion 82B of the hook member 82.

The hook member 83 at the side of the heat sink member 40 is provided at a respective one of the left and right side parts on an upper end wall of the heat sink member 40, in correspondence with the hook member 82 at the side of the reflector 20. The slit 83A is formed on the upper side wall to be upwardly cut out at groove intervals equivalent to the plate thickness of the arm portion 82A. By forming this slit 83A, the hook portion 83B is defined outside in the vehicle widthwise direction thereof.

The hook members 82 and 83 of the hook mechanism 81 is engagingly fitted to each other prior to the activity of positioning relative to the reflector mount surfaces 41, 42 in the heat sink member 40 of the reflector 20.

In other words, prior to inserting locating pins 46 (46A, 46B) of the reflector mount faces 41, 42 into a positioning hole 50 of the oblique flat plate portions 26A, 26B of the reflector 20, the arm portion 82A of the hook member 82 is inserted into and is engagingly fitted to the slit 83A of the hook member 83 from above, and the hook portions 82B, 83B of the hook members 82, 83 are engaged in abutment against each other, whereby the hook mechanism 81 is engagingly fitted.

In this manner, the hook mechanism 81 is engagingly fitted prior to the activity of positioning and fixing the reflector 20 relative to the heat sink member 40, whereby the reflector 20 can be temporarily locked with the heat sink member 40, and the reflector can be easily positioned and fixed. Further, the upper part of the reflector 20 can be positioned in the vehicle widthwise direction and longitudinal direction relative to the heat sink member 40, by means of engagement between the arm portion 82A and the slit 83A in the hook members 82, 83 and engagement between the hook portions 82B and 83B.

In the embodiment, as a warping deformation prevention portion 80 of the reflector 20, in addition to the hook mechanism 81, an abutment mechanism 85 is employed for restraining the reflector 20 from deformation movement in a direction in which the reflector approaches the heat sink member 40.

The abutment mechanism 85 is provided at an intermediate portion between the positioned and fixed portion of the reflector 20 and the hook mechanism 81; and is made up of: an abutment piece 86 at the side of the reflector 20; and an abutment seat portion 87 at the side of the heat sink member 40 against which the abutment piece 86 abuts.

In the embodiment, like the hook mechanism 81, the abutment mechanism 85 is also provided at a respective one of the left and right side parts of the reflector 20 and the heat sink member 40.

The abutment piece 86 is extended longitudinally rearwardly of the lower rear end rim of the rib wall 31 outside of the vehicle widthwise direction of a respective one of the obliquely curved plate portions 24A, 24B in the second reflectors 22A, 22B.

The abutment seat portion 87 is provided at a respective one of the side parts on a recessed bottom surface of the recessed portion 55 in the heat sink member 40, in correspondence with the abutment piece 86.

The abutment seat portion 87 is made up of: a boss portion 87A shaped like a frustum of pyramid; and a sectional triangular, longitudinally elongate protrusion 87B, provided on a top face of the boss portion 87A with which the elongate abutment piece 86 abuts in linear contact.

The rib wall 31 is vertically formed in a convex shape to the outside of the vehicle widthwise direction, along the side rim of the obliquely curved plate portions 24A, 24B, and an abutment piece 86 is extended in a longitudinally elongate manner at a lower rear end rim thereof. In relation to this disposition, the abutment piece 86 is formed in an oblique shape such that a lower side thereof is inwardly oriented.

Therefore, the protrusion 87B of the abutment seat portion 87 is formed so that: a triangular top ridgeline thereof is inclined downwardly outside of the vehicle widthwise direction; and the top ridgeline abuts to be substantially orthogonal to the rear end rim of the abutment piece 86.

These abutment piece 86 and protrusion 87B are abutted in linear contact with each other in the longitudinal direction, by engagingly fitting the hook mechanisms 81 to each other, followed by positioning and fixing the oblique flat plate portions 26A, 26B of the second reflectors 22A, 22B at the reflector mount surfaces 41, 42 of the heat sink member 40.

According to a headlamp of the embodiment, made up of the above constituent elements, the semiconductor-type light source 10 and the reflector 20 are precisely positioned relative to the heat sink member 40 by means of the locating pins 46, 48 and the positioning holes 50, 52, and are securely tightened and fixed by means of a tightening member, whereas the reflector 20 made of a synthetic resin material can be warped and deformed at a portion spaced from the tightened and fixed portion, due to a heat generated from the semiconductor-type light source 10. This is because a heat value thereof increases with higher luminance of the semiconductor-type light source 10 in order to enhance an illumination effect of the headlamp, thus there being a possibility of promoting a warping deformation of the reflector 20 due to the thermal influence.

In particular, as in the embodiment, if the second reflector 22 constituting part of the reflector 20 is formed in a vertically elongate shape, and the positioned and fixed portion is set at the oblique flat plate portion 26 corresponding to the lower end part of the second reflector 22, a warping deformation tends to likely occur at an upper end part of the obliquely curved plate portion 24 corresponding to the upper end part of the second reflector 22.

However, at the upper end part spaced upwardly of the positioned and fixed portion of the second reflector 22, the deformation prevention portion 80 is provided for a respective one of the second reflector 22 and the heat sink member 40, thus preventing a warping deformation of the second reflector 22.

As a result, the impairment of light distribution property, caused by a slight warping deformation of the second reflector 22, can be avoided.

As the deformation prevention portion 80, there is employed a hook mechanism 81 which is engaged between an upper part of the second reflector 22 and that of the heat sink member 40, the hook mechanism being adapted to restrain a deformation movement in a respective one of directions in which the second reflector 22 is spaced from and approaches the heat sink member 40, thus allowing forward and rearward warping deformations to be reliably restrained at the upper end part of the second reflector 22.

In the embodiment, the hook mechanism 81 is constructed in such a manner that: the vertical arm portion 82A in the hook member 82 provided at the reflector side is engagingly fitted to the vertical slit 83A in the hook member 83 at the heat sink member side; and a respective one of the hook portions 82B, 83B of the hook members 82, 83 is engaged in abutment against each other in the longitudinal direction. Thus, when the reflector 20 is assembled with the heat sink member 40, the reflector 20 can be temporarily locked with the heat sink portion 40 by engagingly fitting the hook mechanism 81, allowing the reflector 20 to be easily positioned and fixed in its appropriate location. Further, the upper end part of the reflector 20 is longitudinally and transversely positioned by means of engagement between the arm portion 82A and the slit 83A and abutment engagement between the hook portions 82B and 83B, thus allowing the reflector to highly maintain the precision of a reflected-light path of the semiconductor-type light source 10 reflected by means of the reflector 20.

In addition, at the vertical intermediate part of the reflector 20, i.e., at the vertical intermediate part of the second reflector 22 (a lower part of the obliquely curved plate portion 24), an abutment mechanism 85 is provided as the deformation prevention portion 80, made of an abutment piece 86 provided at the reflector side and an abutment seat portion 87 provided at the heat sink member side, thus allowing the abutment mechanism 85 to reliably restraint a thermal deformation (a warping deformation) in a curved direction of the obliquely curved plate portion 24 of the second reflector 22 (in the approaching direction relative to the heat sink member 40). Moreover, the abutment mechanism 85 is structured in such a manner that an end rim of the longitudinal abutment piece 86 and the top ridgeline of a sectional triangular, transversely elongate protrusion 87B in the abutment seat portion 87 are abutted in linear contact with each other in a crossed state, thus allowing the abutment piece 86 and the abutment seat portion 87 to be free of vertical and horizontal abutment displacements exerted by a molding error therebetween and both of them to be reliably abutted against and engaged with each other.

Further, the deformation prevention portion 80 is provided at a respective one of the left and right sides of the reflector 20 and the heat sink member 40, thus allowing the reflector 20 to be free of a torsional deformation thereof due to the heat generated from the semiconductor-type light source 10 as well.

While, in the embodiment, it is shown that two pairs of reflectors 20A, 20B are integrally molded, of course, an advantageous effect similar to that described previously can be attained by constituting and applying a stand-alone reflector 20.

The reflector 20 is not limitative to the one having the aforementioned structure, and is applicable to the other side as long as it has a structure that a positioning and fixing point thereof is set eccentrically to one side of the reflector.

1. A vehicle lighting device, comprising:
(i) a semiconductor-type light source;
(ii) a reflector having a reflecting surface for reflecting light from the semiconductor-type light source in a predetermined direction;
(iii) a heat sink member in which the semiconductor-type light source and the reflector are positioned and fixed therein, the heat sink member being adapted to radiate a heat from the semiconductor-type light source; and
(iv) a deformation prevention portion which is provided for a respective one of the reflector and the heat sink member at a position spaced from the positioned and fixed site in (iii) and prevents a warping deformation of the reflector due to a heat from the semiconductor-type light source.

2. The vehicle lighting device according to claim 1, wherein:
the deformation prevention portion is made up of a hook mechanism engaged between the reflector and the heat sink, thereby restraining a deformation movement in a respective one of directions in which the reflector is spaced from, and approaches, the heat sink.

3. The vehicle lighting device according to claim 1, wherein:
the deformation prevention portion is made up of an abutment mechanism for restraining the deformation movement in the direction in which the reflector approaches the heat sink member; and
the abutment mechanism comprises an abutment piece which is provided at either one of the reflector and the heat sink member and an abutment seat portion which is provided at the other one, against which the abutment piece abuts.

4. The vehicle lighting device according to claim 1, wherein:
the abutment piece and the abutment seat portion of the abutment mechanism abuts in linear contact with each other.

5. The vehicle lighting device according to claim 1, wherein:
the deformation prevention portion is provided at a respective one of left and right sides of the reflector and the heat sink member.

6. A vehicle lightning device, comprising:
(i) a semiconductor-type light source;
(ii) a reflector having a reflecting surface for reflecting light from the semiconductor-type light source in a predetermined direction;
(iii) a heat sink member in which the semiconductor-type light source and the reflector are positioned and fixed in a first location, the heat sink member being adapted to radiate a heat from the semiconductor-type light source; and
(iv) a deformation prevention portion for preventing a warping deformation of the reflector due to the heat from the semiconductor-type light source, the deformation prevention portion being formed by the reflector being positioned and fixed in the heat sink member in a second location spaced from the portion positioned and fixed in the first location of the heat sink member (iii).

7. The vehicle lighting device according to claim 6, wherein:
the deformation prevention portion is made up of a hook mechanism which is provided for a respective one of the reflector and the heat sink member, which is engaged therewith, and which restrains the deformation movement in directions in which the reflector is spaced from, and approaches, the heat sink member in the second location.

8. The vehicle lighting device according to claim 6, wherein:
the deformation prevention portion comprises an abutment mechanism in which the reflector is formed in abutment against the heat sink member in a third location between the first location and the second location, the abutment mechanism being adapted to restrain the deformation movement in the direction in which the reflector approaches the heat sink member.

9. The vehicle lighting device according to claim 8, wherein:
the abutment mechanism comprises an abutment piece provided at either one of the reflector and the heat sink member and an abutment seat portion provided at the other one, against which the abutment piece abuts.

10. The vehicle lighting device according to claim 8, wherein:
a plurality of ribs are erected on a back face of the heat sink member; and
the abutment mechanism is arranged on a top face of the heat sink member corresponding to the plurality of ribs erected on the back face of the heat sink member.

11. The vehicle lighting device according to claim 9, wherein:
the abutment piece and the abutment seat portion of the abutment mechanism abut in linear contact with each other.

12. The vehicle lighting device according to claim 6, wherein:
the deformation prevention portion comprises:
a hook mechanism which is provided for a respective one of the reflector and the heat sink member and restrains a deformation movement in the direction in which the reflector is spaced from, and approaches, the heat sink member at the second location; and
an abutment mechanism in which the reflector is formed in abutment against with the heat sink member at the third location between the first location and the second location, the abutment mechanism being adapted to restrain the deformation movement in the direction in which the reflector approaches the heat sink member.

13. The vehicle lighting device according to claim 6, wherein:
the deformation prevention portion is provided at a respective one of left and right sides of the reflector and the heat sink member.

14. A vehicle lighting device, comprising:
(i) first and second semiconductor-type light sources;
(ii) a first reflector having a reflecting surface for reflecting light from the first semiconductor-type light source in a predetermined direction;
(iii) a second reflector having a reflecting surface for reflecting light from the second semiconductor-type light source in a predetermined direction;
(iv) a heat sink member in which the first semiconductor-type light source and the first reflector are positioned and fixed in a first location and the second semiconductor-type light source and the second reflector are positioned and fixed in parallel thereto, the heat sink member being adapted to radiate a heat from a respective one of the first and second semiconductor-type light sources; and
(v) a deformation prevention portion for preventing a warping deformation of the first reflector due to a heat of the first semiconductor-type light source and a warping deformation of the second reflector due to a heat from the second semiconductor-type light source, the deformation prevention portion being formed by the first reflector and the second reflector being positioned and fixed in the heat sink member in a second location upwardly spaced from the portion positioned and fixed in the first location of (iv).

15. The vehicle lighting device according to claim 14, wherein:
the first reflector and the second reflector are integrally molded; and
the deformation prevention portion comprises:
a first hook mechanism which is provided for each of one end side of the first reflector and the heat sink member and restrains a deformation movement in a respective one of directions in which the first reflector is spaced from, and approaches, the heat sink member, in the second location; and
a second hook mechanism which is provided for each of one end side of the second reflector and the heat sink member, and restrains a deformation movement in a respective one of directions in which the second reflector is spaced from, and approaches, the heat sink member, in the second location.

16. The vehicle lighting device according to claim 14, wherein:
the deformation prevention portion comprises:
a first abutment mechanism in which the first reflector is formed in abutment against the heat sink member in a third location between the first location and the second location, the first abutment mechanism being adapted to restrain the deformation movement in the direction in which the first reflector approaches the heat sink member; and
a second abutment mechanism in which the second reflector is formed in abutment against the heat sink member in the third location, the second abutment mechanism being adapted to restrain the deformation movement in the direction in which the second reflector approaches the heat sink member.
